(19) United States
(12) Patent Application Publication
(10) Pub. No.: US 2012/0246009 A1
(43) Pub. Date: Sep. 27, 2012

(54) Cross Marketing Tool Using a Customer Profile

(75) Inventors: Basil Hafez, New York, NY (US); Antony Petersen, New York, NY (US); David Cunha, Hoboken, NJ (US); Michael Curtes, New York, NY (US); Matthew Mahony, Hoboken, NJ (US)

(73) Assignee: Viacom International, Inc., New York, NY (US)

(21) Appl. No.: 13/335,600

(22) Filed: Dec. 22, 2011

Related U.S. Application Data
(63) Continuation-in-part of application No. 13/052,970, filed on Mar. 21, 2011.

(51) Int. Cl. G06Q 30/02

(52) U.S. Cl. 705/14.66

(57) ABSTRACT

The technology features a method and computer program product that can be used to provide a system and interface for generating a graphical representation on a mobile device such that consumers can view advertisements interspersed with other applications in a visually appealing fashion. The subject matter also includes a recommendation engine that will include specific content applications based on keywords associated with each specific content application. The recommendation engine can compare keywords associated with a content application to keywords associated with a customer profile. The recommendation can use matching keywords to associate a production list with content applications associated with the matching keywords. The production list can then be used to populate a graphical presentation on the mobile device with graphics associated with content applications on the production list.

### CROSS-REFERENCE TO RELATED APPLICATION

This application is a continuation-in-part of U.S. patent application Ser. No. 13/052,970 filed Mar. 21, 2011, which is owned by the assignee of the instant application and the disclosure of which is incorporated herein by reference in its entirety.

### FIELD OF THE INVENTION

The present invention relates generally to graphical representations on a mobile device.

### BACKGROUND OF THE INVENTION

The market for mobile device applications is both lucrative and growing. Some popular categories of mobile device applications are, for example, games, utilities, news, entertainment and social networking. As the popularity of mobile devices capable of running applications has grown, so has the number of mobile device applications. Additionally, since there are now multiple platforms on which mobile device applications can run, there can be multiple versions of each mobile device application. Although some developers of mobile device applications develop applications for fun and are willing to distribute their applications for free, there are other developers who develop applications with the intent to generate revenue.

Developers of mobile device applications have a number of ways to generate revenue for their applications. One common way is for a developer to charge a fee to download the applications. Another way is for a developer to allow consumers to download the applications for free, but require that advertisements be displayed during use of the application. In this manner, the developer would instead generate revenue by charging advertisers a fee (as opposed to the consumer) in exchange for their advertisements to be displayed during use of the developer's application. The amount an advertiser pays a developer can be dependent on factors such as how many times consumers see their advertisements, how many times consumers choose to view their advertisements (e.g. selects an advertisement to view), or how often advertisements are displayed to a consumer. Developers that utilize advertisements in their applications would therefore be able to generate more revenue if their applications were able to display advertisements constantly, and/or consumers would choose to select to view the advertisements.

One problem with advertisements in mobile applications is that the advertisements tend to clutter a mobile device's screen, which is not visually appealing. This reason may hamper a consumer's enjoyment of an application, meaning a consumer may choose not to use the application or may choose to use the application less often. This would lead to less revenue being generated by the developer. Consequently, consumers are less likely to choose to view an advertisement if the advertisement hinders the consumer's enjoyment of the application. A balance must be struck between having a functional application and being able to display visually appealing advertisements that are capable of inducing consumers to select to view them within a mobile application.

### SUMMARY OF THE INVENTION

The technology features a method that can be used to provide a graphical representation on a mobile device such that consumers can view advertisements interspersed with other applications in a visually appealing fashion. The graphical representation can be integrated with a main representation such that it can appear to be seamless and unobtrusive. The graphical representation can invite consumers to select both other mobile device applications and advertisements.

In one aspect, the technology includes a method for providing a graphical presentation on a mobile device. A master list of one or more content applications can be accessed by a computer from a server, each content application being associated with a displayable graphic and representing at least one of a mobile device application and an advertisement, and including at least one application keyword. The master list can be displayed on a user interface of the computer, which can also display the master list. The method further includes the computer accessing a database for one or more customer profiles, with each customer profile including at least one customer keyword. The computer then generates a production list of one or more content applications based on the selections. The production list is then transmitted, by a transceiver, to the mobile device, where the graphical presentation is based on the production list.

Another aspect of the technology includes a computer program product, tangibly embodied in a computer-readable storage medium, for providing a graphical presentation on a mobile device. The computer program product comprising instructions operable to cause a data processing apparatus to access, by a computer from a server, a master list of one or more content applications, each content application being associated with a displayable graphic, representing at least one of a mobile device application and an advertisement, and including at least one application keyword. The computer program product also includes instructions for the computer to access a database for one or more customer profiles, with each customer profile including at least one customer keyword. The computer program product also includes instructions to display the master list on a user interface of the computer. The computer program product also includes instructions for the computer to generate a production list that comprises the one or more selected content applications. Finally, the computer program product can include instructions to transmit the production list by a transceiver to the mobile device. The graphical presentation displayed on the mobile device is based on the production list and uses the displayable graphics associated with the one or more content applications in the production list.

Each aspect described above can include one or more of the following features. The one or more content applications can include at least one application keyword that matches the at least one customer keyword of the one or more customer profiles. The one or more content applications can include at least one advertisement and at least one mobile device application. The computer can add a recommendation indication to the one or more content applications when the at least one application keyword of the content applications matches the customer keyword of the customer profile. The indications of selected content applications can be used by the computer to transfer the one or more content applications from the master list into the production list. In some embodiments, a content application can include a requirement indication so that the computer always transfers the content application to the production list. And the selected content applications can be removed by transferring the content application from the production list into the master list. In some embodiments, the transferring is done by dragging and dropping.

The aspects above can also include one or more of the following features. The graphics associated with each of the one or more content applications are presented in the graphical presentation in an order that is reflected in the production list. And a most visible location on the graphical presentation is reserved for a graphic associated with an advertisement. The mobile device displays the graphical presentation together with a main presentation. In some embodiments, a content application can also be presented in the main presentation, and selecting a graphic in the graphical presentation can change the main presentation to display the content application associated with the graphic. In some embodiments, selecting a graphic in the graphical presentation will display a pop-up window over the graphical presentation and the main presentation. In some embodiments, the graphical presentation is associated with the content application; and in some embodiments, after selecting the graphic in the graphical presentation, the graphical representation will display a download page for the content application associated with the graphic. In some embodiments, after selecting the graphic in the graphical presentation, the graphical presentation will change to the graphical presentation associated with the content application.

Each of the aspects above can further include one or more of the following features. The filtering of the production list can be base don a profile of the mobile device. And in some embodiments, the filtering is done by at least one of the computing device, a second server, and the mobile device.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a graphical representation of devices including a server, a computing device, and a mobile device.

FIG. 2 is a graphical user interface illustrating a master list of available indications of content applications and a production list containing indications of content applications.

FIG. 3A is a graphical representation of a drag and drop method to add an indication of a content application from a master list to a production list.

FIG. 3B is a graphical representation of a drag and drop method to remove an indication of a content application from a production list to a master list.

FIG. 4A is a graphical representation of a method to add an indication of a content application from a master list to a production list.

FIG. 4B is a graphical representation of a method to remove an indication of a content application from a production list to a master list.

FIG. 5 is a flow chart illustrating a filtering process for a production list.

FIG. 6 is a graphical representation of a main presentation and a graphical representation displayed on a mobile device.

### DETAILED DESCRIPTION OF THE TECHNOLOGY

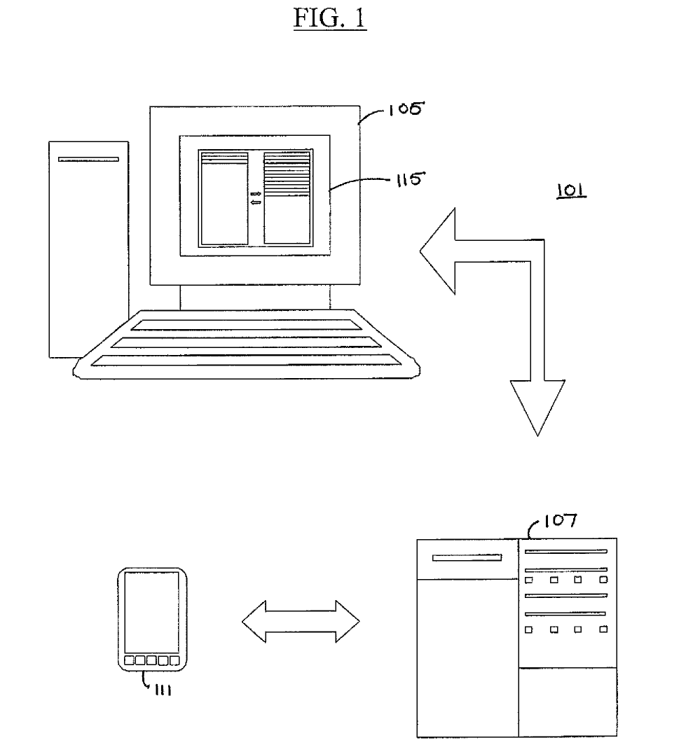

FIG. 1 shows a graphical representation of a communication network 101 that uses a computing device 105, a server 107, and a mobile device 111. A database is stored in the server 107. In some embodiments, the server 107 may store multiple databases. The computing device 105 can be used to access the database and can display a graphical user interface 115 representing entries saved in the database. The computing device can be, for example, a personal computing device. The database can be manipulated by the computing device 105. Changes made to the database can be saved on the server 107. In some embodiments, the database can include instructions that determine what is displayed on the mobile device 111. In some embodiments, the mobile device 111 can be any portable device with a screen, such as smartphones, music players, tablets, e-readers, netbooks, and laptops.

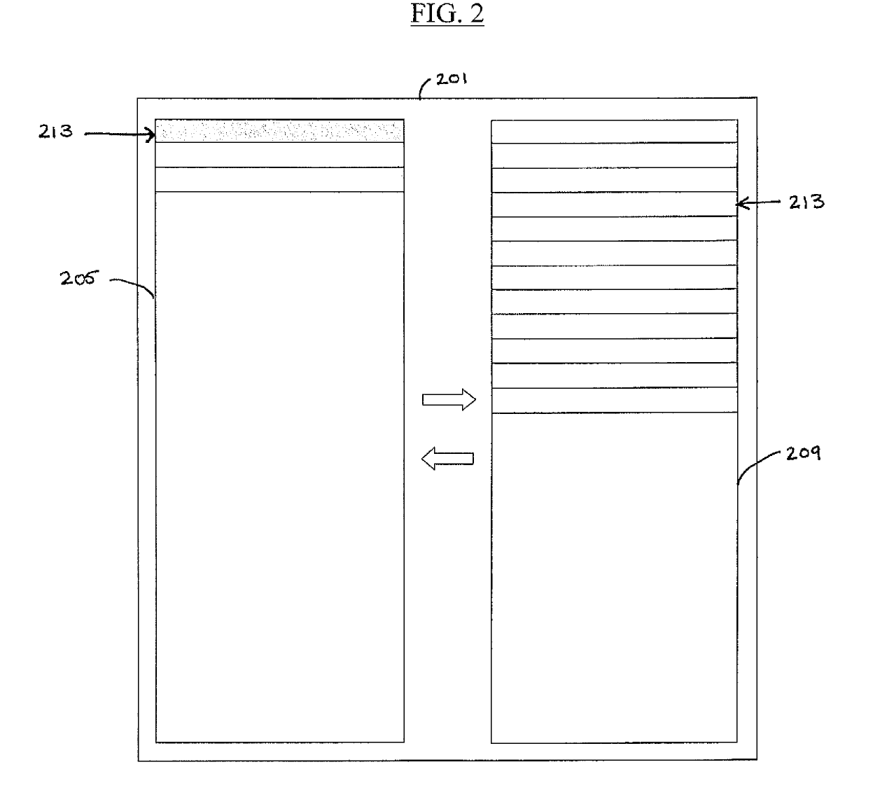

In some embodiments, for example FIG. 2, a graphical user interface 201 can display a master list 205 and a production list 209. The master list 205 and the production list 209 can show that information that is stored in the database of FIG. 1. In both the master list 205 and the production list 209 include lists of content applications 213. The content application can represent either a mobile device application or an advertisement. All content applications that are stored in the database can be shown in the master list 205. In some embodiments, only a subset of the full set of content applications stored in the database are displayed in the master list 205. In some embodiments, the subset is selected by the user, and in other embodiments, the subset is selected by the database based on saved criteria. The saved criteria can include age appropriate restrictions, gender restrictions or any other restrictions that are useful to the user in defining the anticipated mobile device user group. Once the user of the system has indicated that they want to select a content application for display on the mobile device 111, the listing of the selected content application is moved to the production list 209. A variety of methods of moving the selected content application from the master list to the production list can be utilized, and will be described below. In some embodiments, the creation of the production list can include advertising applications and mobile device applications, e.g., games. In some embodiments, the production list only includes mobile device applications and the advertisement applications are added to the graphical display on the mobile device base don a preselected list that is maintained in the database.

The production list 209 can be required to contain at least one content application 213 representing a mobile device application and at least one content application representing an advertisement. In some embodiments, the content application representing the advertisement can provide, for example, a link to an advertiser's website, videos, images and other types of media promoting the advertiser's product, or another mobile device application developed solely to promote the advertiser's product. In some embodiments, the content application representing the mobile device application can provide, for example, a link to a web-based application, another mobile device application, a demo of another mobile device application, or an invitation to purchase or download another mobile device application. Examples of content applications can include an application for reading articles from MTV News, a SpongeBob Tickler game application and a Beavis and Butt-head application that includes mini-games and episodes clips with an option to download full episodes of the Beavis and Butt-head TV show.

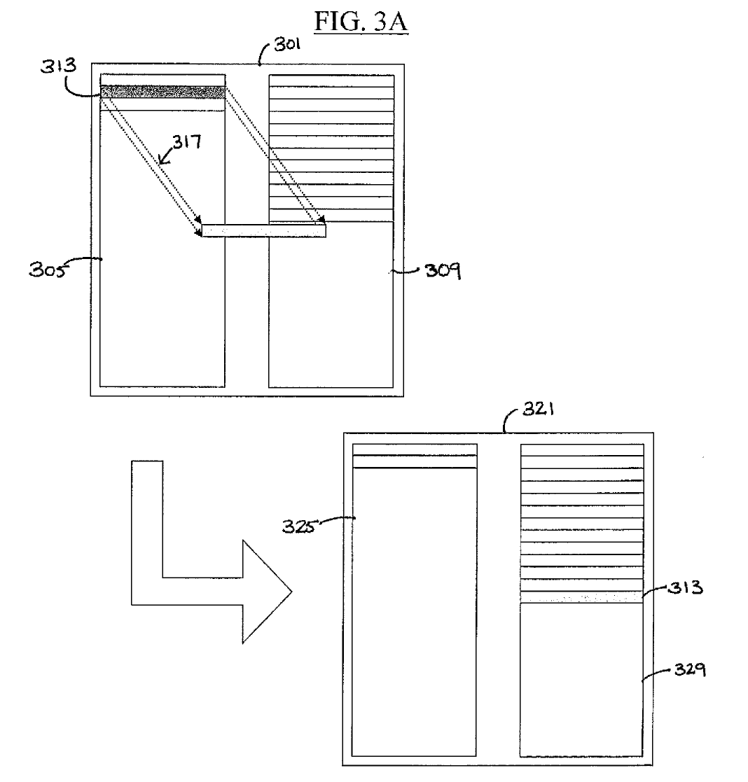

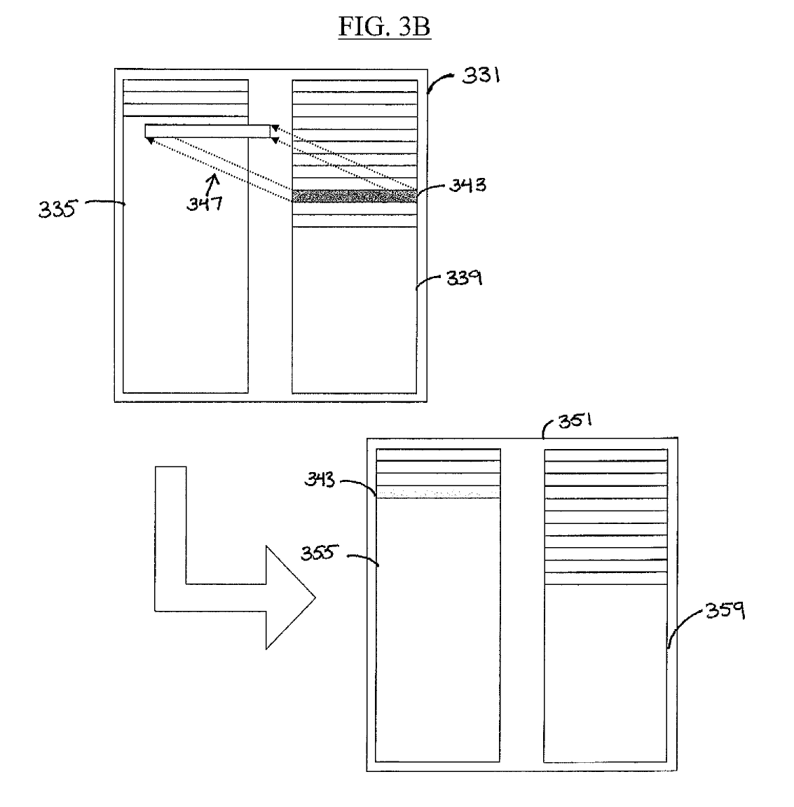

FIG. 3A shows a graphical representation of adding a selected content application to a production list. In some embodiments, a graphical user interface 301 can display a master list 305 and a production list 309. A content application 313 can be dragged from the master list 305 into the production list 309. Dragging the selected content application 213 from the master list to the production list provides an indication to the computing system that the selected content application should be displayed as a graphic on the mobile device. The drag-and-drop 317 moves the selected content application 313 from a master list to a production list. After the drag-and-drop 317, the selected content application 313 can be found in the updated production list 329. As a result of the drag-and-drop 317, the graphical user interface 301 is updated and an updated graphical user interface 321 is generated. In some embodiments, in the updated graphical user interface 321, an updated master list 325 has one less content application 313 listed than the master list 305 and an updated production list 329 has one more content application 313 listed than the production list 309. In some embodiments, the selected content application 313 appears in the updated production list 329 and also remains in the master list as it appeared in the graphical user interface 301.

FIG. 3B shows a graphical representation of removing a selected content application 343 from a production list 339. In some embodiments, a graphical user interface 331 can display a master list 335 and a production list 339. The selected content application 343 can be dragged from the production list 339 into the master list 335. The drag-and-drop 347 moves the selected content application 343 from a production list 339 to a master list 335. After the drag-and-drop 347, the selected content application 343 can be found in the updated master list 355. As a result of the drag-and-drop 347, the graphical user interface 331 is updated to form an updated graphical user interface 351. In the updated graphical user interface 351, an updated master list 355 includes the selected content application 343 while the updated production list 359 no longer includes the selected content application 343. In some embodiments, the selected content application was always shown in the master list 335, but by dragging the selected content application from the production list 339 to the master list 335, the updated production list 359 no longer shows the selected content application 343, but the master list 335 and the updated master list 355 are visual identical.

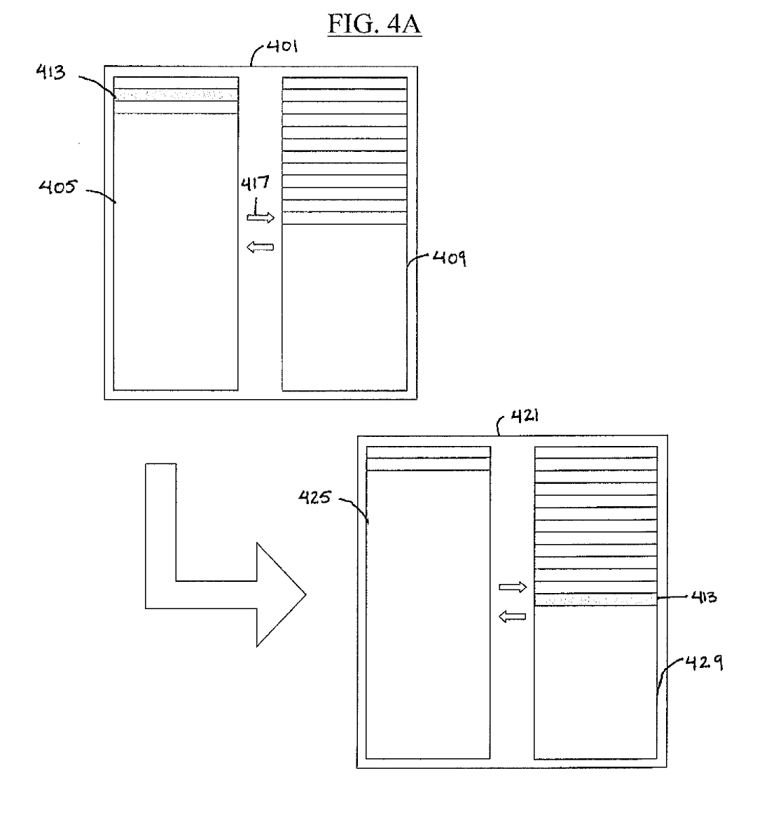

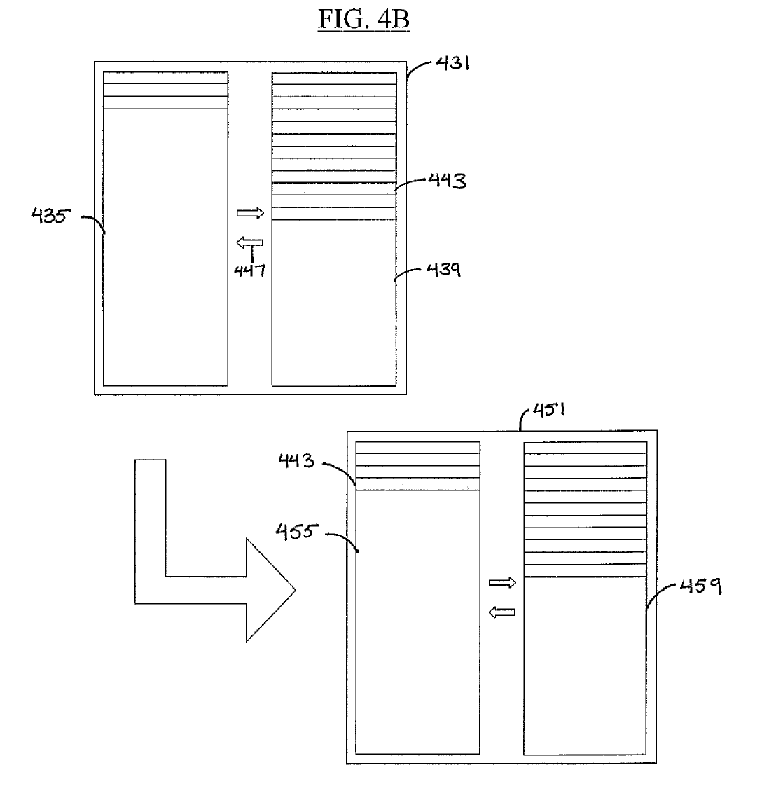

FIG. 4A shows a graphical representation of another embodiment to add a selected content application to a production list. A graphical user interface 401 can display a master list 405 and a production list 409. A selected content application 413 can be moved from the master list 405 into the production list 409 by utilizing an add function 417. Utilizing the add function 417 moves the selected content application 413 from a master list to a production list. After utilizing the add function 417, the selected content application 413 can be found in the updated production list 429. As a result of utilizing the add function 417, the graphical user interface 401 can be updated to generate an updated graphical user interface 421. In the graphical user interface 421, an updated master list 425 can have one less selected content application 413 than the master list 405 and an updated production list 429 has one more selected content application 413 than the production list 409. In some embodiments, the master list 405 is visually identical to the updated master list 425.

FIG. 4B shows a graphical representation of another embodiment to remove a selected content application from a production list. In some embodiments, a graphical user interface 431 can display a master list 435 and a production list 439. A selected content application 443 can be moved from the production list 439 into the master list 435 by utilizing a remove function 447. Utilizing the remove function 447 moves the selected content application 443 from a production list to a master list. After utilizing the remove function 447, the selected content application 443 can be found in the updated master list 455. As a result of utilizing the remove function 447, the graphical user interface 431 is updated and an updated graphical user interface 451 is generated. In the updated graphical user interface 451, an updated master list 455 can have one more selected content application 443 than the master list 435 and an updated production list 459 can have one less selected content application 433 than the production list 439. In some embodiments, the master list 405 is visually identical to the updated master list 425 and only the content applications listed in the production list

Other possible embodiments of the adding and/or removing selected content applications can be characterized by its ease of use and does not require programming skills or knowledge pertaining to manipulating database in order to generate or edit a production list.

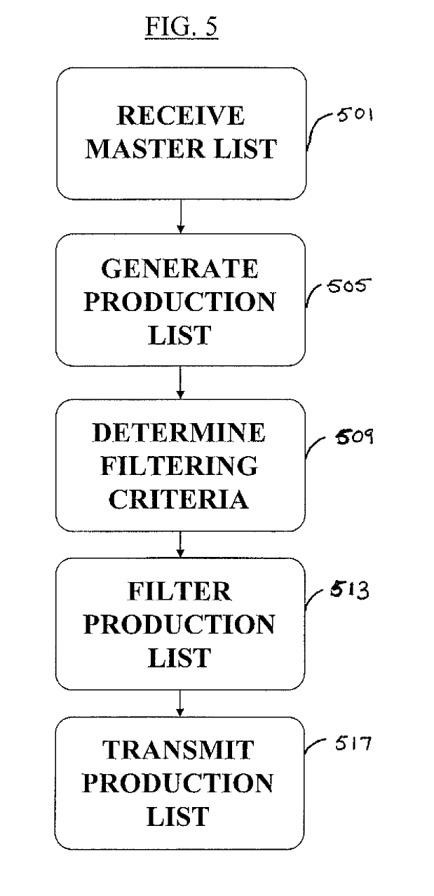

FIG. 5 shows a flow chart of a filtering process for the production list. At step 501, a computing device can receive a master list. The master list can contain all available content applications. In some embodiments, the content applications can include or be associated with contents that can be used in the filtering process. For example, each of the content applications can include one or more application keywords that are associated with the application and the interests of the content applications' target audience. In some instances, such keywords can include contents of the content application itself, such as the game genre, character names, or publisher of the content application. In other instances, such application keywords can include keywords for a targeted audience, such as a keyword of a specific university that would target that school's alumni, or a target age range based on a target customer's birth date.

At step 505, a production list can be generated based on any criteria. For example, the production list can be generated using application keywords associated with the content applications. In some embodiments, a customer profile database can be accessed. The customer profile can include a list of values associated with one or more specific customers. For example, in some embodiments, the customer profile can include data and customer keywords associated with a specific mobile-device customer. Such data can be saved in the database from data retrieved directly from a mobile device, or from other sources where a customer can input such information, such as an associated website. In other embodiments, the customer profile can be a composite customer profile that is generated based on a plurality of specific customer profiles that have similar values. For example, a composite customer profile of a fan of Spongebob Squarepants can include a specific age range that is determined based on the ages of all customers that are fans of Spongebob Squarepants, along with a list of other common customer keywords. In some embodiments, the list of keywords can be stored in the form of a comma-delimited list and accessed using known methods.

In some embodiments, a recommendation engine can generate a production list based on specific criteria. For example, the recommendation engine can access both the customer profiles and the application keywords and can populate the production list based on the comparison. This occurs when the application keyword included with the content application matches a customer keyword included in an accessed customer profile. The production list generated by the recommendation engine can be required to contain one or more content applications associated with the specific criteria.

In other embodiments, the production list can be generated without the recommendation engine. The production list can also be required to contain one or more selected content applications. The production list can be required to contain at least two content applications.

At step 509, a determination can be made as to what filtering criterion can be used. It can be possible that no criterion is used. At step 513, the production list is filtered based on the filtering criterion. Filtering can remove certain indications of selections from the production list. Filtering can be facilitated with the use of one or more tags associated with a content application, such that the one or more tags are indicative of possible criterion. At step 517, the filtered production list can be transmitted to a mobile device. The mobile device can be permitted to only display the applications from the filtered production list.

In some embodiments, determining the filtering criterion at step 509 can be done in various ways. For example, the filtering criterion can be based on a particular mobile device platform. Filtering based on the particular mobile device platform may be necessary because not all mobile device applications can be executed as intended on every mobile device. This can be due to compatibility issues (e.g. the mobile device application will not run on a particular mobile device platform) or performance issues (e.g. the mobile device application will run too slowly on a particular mobile device platform). In other embodiments, filtering can be done after determining the particular mobile device being used. Like with filtering based on a mobile device platform, each type of mobile device may have its own compatibility or performance issues (e.g. some devices may not have the memory or computing power necessary to execute an application or the screen size on a mobile device is too small to properly display the application). Filtering can also be done based on a profile of a particular mobile device. The profile can contain, for example, information such as user preferences and parental controls. In some embodiments, the filtering can be done by a computing device, a server, or a mobile device. In some embodiments, there may be multiple filtering criteria. This can occur when the content application includes a requirement indication that would prevent the content application from otherwise being removed from the filtered production list.

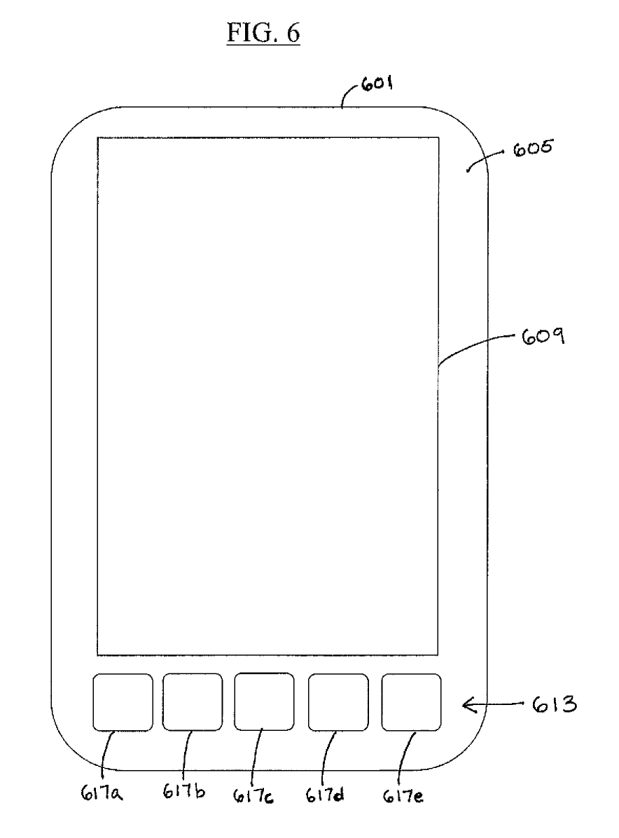

FIG. 6 shows a mobile device 601 with a screen 605. The screen 605 can display a main presentation 609. The screen 605 can also display a graphical presentation 613. In some embodiments, the screen 605 can display the main presentation 609 together with the graphical presentation 613. The main presentation 609 can display a content application. In some embodiments, the graphical presentation 613 can display at least one content application. The arrangement of the main presentation 609 and the graphical presentation 613 can vary. For example, in the illustrative embodiment, the main presentation 609 inhabits a majority of the screen 605, with the graphical presentation 613 inhabiting the rest of the screen 605. In some embodiments, the ratio may differ, as the graphical presentation 613 can inhabit a majority of the screen 605. For example, the graphical presentation 613 can include multiple rows of graphics 617a-617e.

In some embodiments, the graphical presentation 613 can contain multiple graphics 617. In some embodiments, selecting a graphic 617 from the graphical presentation 613 can change the main presentation 609 to display, for example, a download page for the content application associated with the graphic 617. Similarly, selecting a graphic 617 can also change the main presentation 609 to display a different content application that is associated with the graphic 617. For example, if a main presentation 609 is currently displaying a game as the content application, a user of the mobile device 601 can select a graphic 617 associated with an advertisement. After the selection, the main presentation 609 can then change and display the advertisement associated with the graphic 617.

In some embodiments, the graphics 617 in the graphical presentation 613 can be displayed and selected independent to the main presentation 609. For example, the main presentation 609 can display one or more “featured” graphics, where selecting the featured graphic, e.g., through a mouse click or finger press, can change the screen 605 to display a linked object, such as a website associated with the featured graphic. In such embodiments, the graphics 617 in the graphical presentation 613 can change the screen 605 to display a pop-up display associated with the content presentation instead of changing the main presentation 609. In effect, the pop-up display is presented an overlaying a portion of the screen 605. In some embodiments, the pop-up display can have different dimensions than the screen 605. The dimensions of the pop-up screen can also be based on the dimensions of the screen 605 such that the pop-up display is sized to inhabit a percentage of the screen 605, e.g., 75 percent. Or, in some embodiments, the pop-display can be expanded cover the entire screen 605 upon selection. In any of these embodiments, whether a pop up is displayed or whether the screen 605 is changed is dependent on the user's device. For example, on an iPhone, the screen 605 is changed, but when the same is displayed on an iPad, which has larger physical dimensions, the pop-up version is used.

Each graphic 617 represents a content application by providing a visual cue as which content application is associated with the graphic 617. The graphics 617 can be presented in an order than is reflected in a production list. For example, if a production list contains five indications of selection, a first-ordered selected content application in the production list can be represented by a graphic 617a. A second-ordered selected content application in the production list can be represented by a graphic 617b. A third-, fourth- and fifth-ordered selected content application can be presented by a graphic 617c, 617d, and 617e, respectively. In some embodiments, the graphical presentation 613 can include multiple rows of graphics 617. In some embodiments, content applications can be grouped together as to be displayed together in the graphical presentation. For example, the production list can be ordered so that the five indications of selection share a common element, such as a common keyword.

In some embodiments, the graphical representation can have more graphics 617 than visible locations. If there are more graphics 617 than visible locations, the graphics 617 can scroll to reveal other graphics 617. For example, the graphics 617 can scroll to the right whereby the graphical representation can display a constant number of graphics 617, but the graphics 617 can change dependent on the number of content applications in the production list. In some embodiments, the scrolling can display a new group of graphics 617 so that the graphical presentation 613 displays a constant number of graphics 617, but all of the graphical presentation 613 changes from displaying a first group to a second group of graphics 617. In other embodiments, a most visible location on a graphical representation 613 can be reserved for a graphic 617 associated with an advertisement. Reserving the most visible location on the graphical representation can be very lucrative for a developer as the most visible location is most desirable for advertisers. For example, if a middle graphic is the most visible, graphic 617c can be reserved for graphics associated only with advertisements.

In other embodiments, each content application can be associated with a specific graphical representation 613. Associating the specific graphical representation 613 with the content application can require that each content application have its own production list. In some embodiments, the specific graphical representation may also include graphical keywords. In such instances, the recommendation engine may include content applications with application keywords that match one or more keywords of the specific graphical representation 613. Changing the main presentation 609 by selecting a graphic 617 can also change the graphical presentation 613 such that the graphical presentation 613 will be the one associated with the content application to be displayed on the main presentation 609. The graphic representation 613 can be used with any main presentation 609 and can be a stand-alone method of advertising within any mobile device application. Data collection may also be done on the mobile device 601. Data collection can provide developers valuable insight into habits of consumers and therefore can lead to better understanding of what types of advertisements appeal to consumers. This can allow developers to better target both consumers and advertisers in order to maximize revenue. The data collected can be stored on the mobile device 601 and can be transmitted to a server for further analysis.

One skilled in the art will realize the invention may be embodied in other specific forms without departing from the spirit or essential characteristics thereof. The foregoing embodiments are, therefore, to be considered in all respects illustrative rather than limiting of the invention described herein. Scope of the invention is thus indicated by the appended claims, rather than by the foregoing description, and all changes that come within the meaning and range of equivalency of the claims are, therefore, intended to be embraced therein.

What is claimed is:

1. A method, executed on a computer, for providing content to a mobile device based on a customer profile, the method comprising:
accessing a server, by a computer, for a master list of one or more content applications, each content application:
being associated with a displayable graphic,
representing at least one of a mobile device application and an advertisement, and including at least one application keyword;
accessing a database, by the computer, for one or more customer profiles, each customer profile including at least one customer keyword;
displaying, on a user interface of the computer, the master list;
generating, by the computer, a production list comprising the one or more content applications of the master list; and
transmitting, by a transceiver associated with the server, the production list to a mobile device, wherein the mobile device presents a graphical presentation that uses the displayable graphics associated with the one or more content applications in the production list.

2. The method of claim 1, wherein the one or more content applications in the production list include at least one application keyword that matches the at least one customer keyword of the one or more customer profiles.

3. The method of claim 2, further comprising:
adding, by the computer, a recommendation indication to the one or more content applications when the at least one application keyword of the one or more content applications matches the at least one customer keyword of the one or more customer profiles; and
transferring, by the computer, the one or more content applications including a recommendation indication to the production list.

4. The method of claim 1, further comprising:
determining a particular mobile device platform upon which the mobile device application will be operated; and
filtering the production list by removing content applications that are incompatible with the particular mobile device platform.

5. The method of claim 1, wherein the indications are generated by transferring the two or more content applications from the master list into the production list.

6. The method of claim 1, wherein the each content application further comprises a requirement indication, wherein the content application including the requirement indication is always included in the production list.

7. The method of claim 1, wherein the one or more customer profiles comprises a list of a plurality of customer keywords.

8. The method of claim 7, wherein the one or more content applications in the production list include at least one application keyword that matches the at least one customer keyword of the one or more customer profiles.

9. The method of claim 8, further comprising:
adding, by the computer, a recommendation indication to the one or more content applications when the at least one application keyword of the one or more content applications matches the at least one customer keyword of the one or more customer profiles; and
transferring, by the computer, the one or more content applications including a recommendation indication to the production list.

10. The method of claim 1, wherein the graphics associated with each of the one or more content applications are presented in the graphical presentation in an order that is reflected in the production list.

11. The method of claim 1, wherein the one or more content applications includes at least one advertisement and at least one mobile device application.

12. The method of claim 1, wherein a most visible location on the graphical presentation is reserved for a graphic associated with an advertisement.

13. The method of claim 4, wherein filtering is based on a profile of the mobile device.

14. The method of claim 4, wherein filtering is done by at least of one of the computer, a second server, or the mobile device.

15. The method of claim 1, wherein the mobile device displays the graphical presentation together with a main presentation.

16. The method of claim 15, wherein a content application is presented in the main presentation.

17. The method of claim 16, wherein selecting a graphic in the graphical presentation will change the main presentation to display a download page for the content associated with the graphic.

18. The method of claim 17, wherein the graphical presentation is associated with the content application.

19. The method of claim 18, wherein after selecting the graphic in the graphical presentation, the graphical presentation will change to the graphical presentation associated with the content application.

20. The method of claim 15, wherein selecting a graphic in the graphical presentation will display a pop-up window over the graphical presentation and the main presentation.

21. A computer program product, tangibly embodied in a non-transitory computer-readable storage medium, for providing a graphical presentation on a mobile device, the computer program product comprising instructions operable to cause a data processing apparatus to:
access a server, by a computer, for a master list of one or more content applications, each content application:
being associated with a displayable graphic,
representing at least one of a mobile device application and an advertisement, and
including at least one application keyword;
access a database, by the computer, for one or more customer profiles, each customer profile including at least one customer keyword;
display, on a user interface of the computer, the master list;
generate, by the computer, a production list comprising the one or more content applications of the master list; and
transmit, by a transceiver associated with the server, the production list to a mobile device, wherein the mobile device presents a graphical presentation that uses the displayable graphics associated with the one or more content applications in the production list.
